(19) United States
(12) Patent Application Publication
(10) Pub. No.: US 2014/0226233 A1
(43) Pub. Date: Aug. 14, 2014

(54) STORAGE DEVICE WITH REFLECTION COMPENSATION CIRCUITRY

(71) Applicant: LSI CORPORATION, San Jose, CA (US)

(72) Inventors: Boris Livshitz, Eagan, MN (US); Anamul Hoque, Lakeville, MN (US); Cameron C. Rabe, Inver Grove Heights, MN (US); Jeffrey A. Gleason, Burnsville, MN (US)

(73) Assignee: LSI Corporation, San Jose, CA (US)

(21) Appl. No.: 13/762,686

(22) Filed: Feb. 8, 2013

(51) Int. Cl. G11B 20/22

(52) U.S. Cl. CPC G11B 20/22
USPC 360/40; 360/46

(57) ABSTRACT

A hard disk drive or other storage device comprises a storage medium, a write head configured to write data to the storage medium, and control circuitry coupled to the write head. The control circuitry comprises a write driver configured to generate a write signal comprising a write pulse, and reflection compensation circuitry coupled to or otherwise associated with the write driver and configured to provide one or more reflection compensation pulses in the write pulse.

### FIELD

The field relates generally to storage devices, and more particularly to generation of write signals in storage devices.

### BACKGROUND

Disk-based storage devices such as hard disk drives (HDDs) are commonly used to provide non-volatile data storage in a wide variety of different types of data processing systems.

In a typical HDD, data is recorded on tracks of a magnetic storage disk using a write signal comprising multiple write pulses. The write signal is generated by a write driver that is coupled to a write head of the HDD via a transmission line. In order to record a given data bit, the write driver generates a write pulse that transitions from a negative write current to a positive write current, or vice-versa.

However, writing data to the storage disk can be challenging when utilizing conventional write pulses, particularly at high data rates on the order of 1 Gigabit per second (Gb/s) or more. For example, impedance mismatches between the write driver, the transmission line and the write head often cause write pulse reflections that distort the desired shape of the write pulse waveform at the write head. Such impedance mismatches become significantly more pronounced at high data rates, and can adversely impact on-track recording performance in terms of recorded data fidelity as well as off-track recording performance due to issues such as adjacent track erasure and far track erasure. Similar problems can arise when writing data to other types of storage media.

### SUMMARY

In one embodiment, an HDD or other storage device comprises a storage medium, a write head configured to write data to the storage medium, and control circuitry coupled to the write head. The control circuitry comprises a write driver configured to generate a write signal comprising a write pulse, and reflection compensation circuitry coupled to or otherwise associated with the write driver and configured to provide one or more reflection compensation pulses in the write pulse.

By way of example only, the reflection compensation circuitry may be configured to generate a given one of the reflection compensation pulses as a negative-going current pulse having a substantially zero steady-state current. The reflection compensation circuitry may be further configured to superimpose the given reflection compensation pulse on the write pulse by combining the negative-going current pulse having the substantially zero steady-state current with a positive steady-state write current of the write pulse so as to produce a modified write pulse having the negative-going current pulse superimposed on the positive steady-state write current.

Other embodiments of the invention include but are not limited to methods, apparatus, systems, processing devices, integrated circuits and computer-readable storage media having computer program code embodied therein.

### BRIEF DESCRIPTION OF THE DRAWINGS

FIG. 1 shows a perspective view of a disk-based storage device in accordance with an illustrative embodiment of the invention.

FIG. 2 shows a plan view of a storage disk in the storage device of FIG. 1.

FIG. 3 is a block diagram of a portion of the storage device of FIG. 1 including a preamplifier comprising multiple write drivers and associated reflection compensation circuitry.

FIG. 4 shows an example of a write signal comprising a write pulse without a superimposed reflection compensation pulse.

FIG. 5 shows an example of a write signal comprising a write pulse with a superimposed reflection compensation pulse.

FIGS. 6A, 6B and 6C illustrate the operation of a portion of the reflection compensation circuitry associated with a given write driver of FIG. 3.

FIG. 7 illustrates interconnection of the storage device of FIG. 1 with a host processing device in a data processing system.

FIG. 8 shows a virtual storage system incorporating a plurality of disk-based storage devices of the type shown in FIG. 1.

### DETAILED DESCRIPTION

Embodiments of the invention will be illustrated herein in conjunction with exemplary disk-based storage devices, write drivers and associated reflection compensation circuitry. It should be understood, however, that these and other embodiments of the invention are more generally applicable to any storage device in which improved recording performance is desired. Additional embodiments may be implemented using components other than those specifically shown and described in conjunction with the illustrative embodiments.

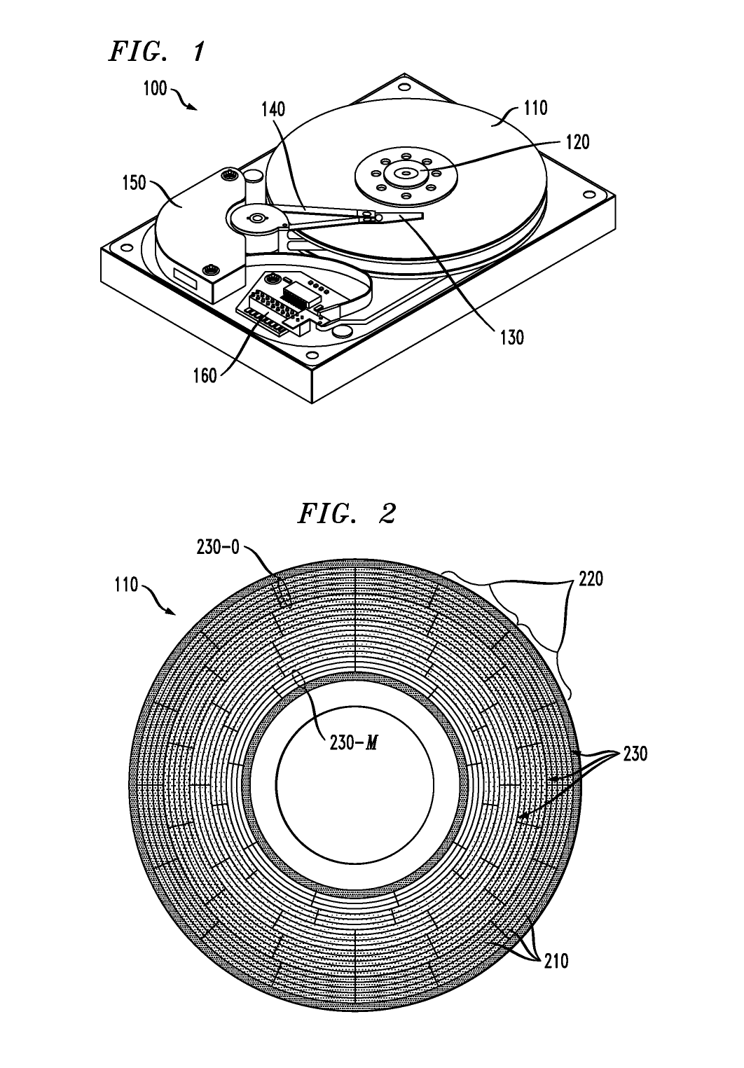

FIG. 1 shows a disk-based storage device 100 in accordance with an illustrative embodiment of the invention. The storage device 100 in this embodiment more specifically comprises an HDD that includes a storage disk 110. The storage disk 110 has a storage surface coated with one or more magnetic materials that are capable of storing data bits in the form of respective groups of media grains oriented in a common magnetization direction (e.g., up or down). The storage disk 110 is connected to a spindle 120. The spindle 120 is driven by a spindle motor, not explicitly shown in the figure, in order to spin the storage disk 110 at high speed.

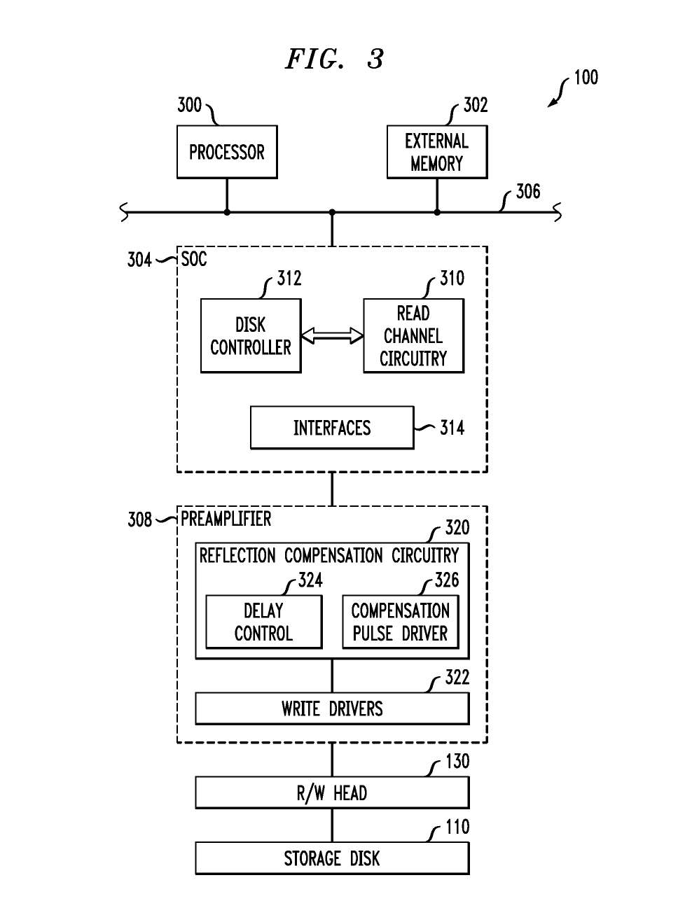

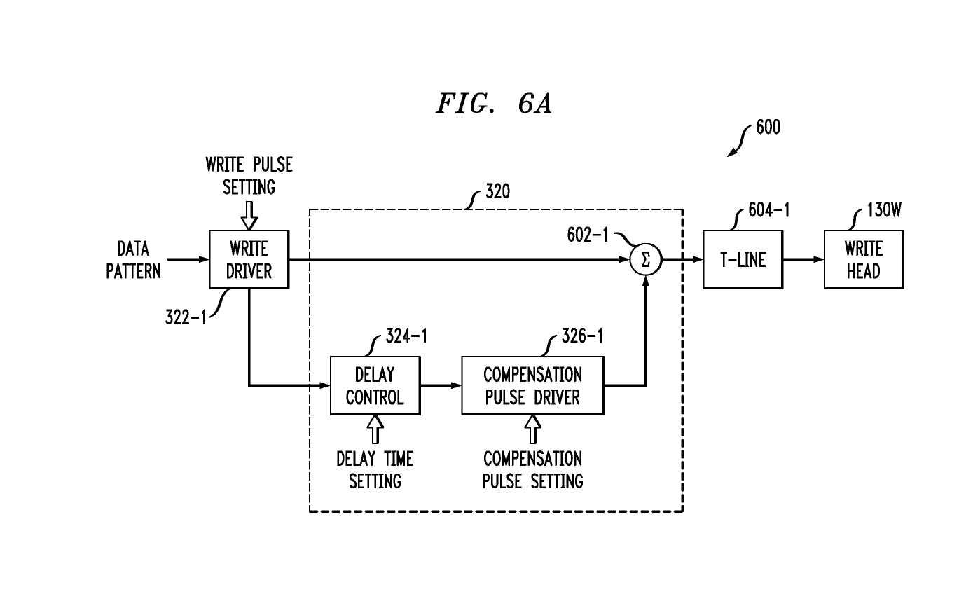

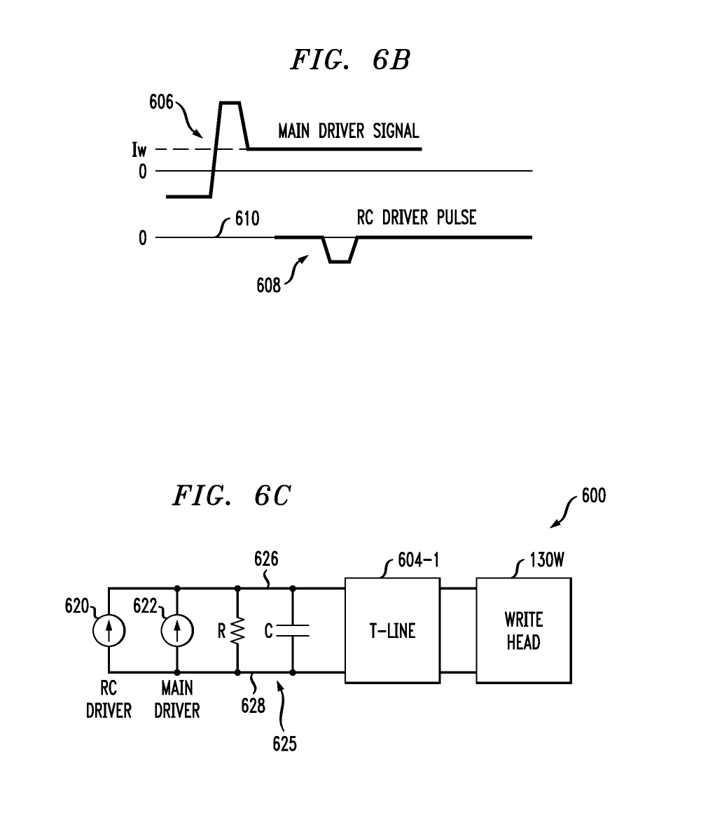

Data is read from and written to the storage disk 110 via a read/write head 130 that is mounted on a positioning arm 140. It is to be appreciated that the head 130 is shown only generally in FIG. 1. The position of the read/write head 130 over the magnetic surface of the storage disk 110 is controlled by an electromagnetic actuator 150. The electromagnetic actuator 150 and its associated driver circuitry in the present embodiment may be viewed as comprising a portion of what is more generally referred to herein as “control circuitry” of the storage device 100. Such control circuitry in this embodiment is assumed to further include additional electronics components arranged on an opposite side of the assembly and therefore not visible in the perspective view of FIG. 1. Examples of such additional components will be shown in other figures, such as FIGS. 3 and 6.

The term “control circuitry” as used herein is therefore intended to be broadly construed so as to encompass, by way of example and without limitation, drive electronics, signal processing electronics, and associated processing and memory circuitry, and may encompass additional or alternative elements utilized to control positioning of a read/write head relative to a storage surface of a storage disk in a storage device. A connector 160 is used to connect the storage device 100 to a host computer or other related processing device.

It is to be appreciated that, although FIG. 1 shows an embodiment of the invention with only one instance of each of the single storage disk 110, read/write head 130, and positioning arm 140, this is by way of illustrative example only, and alternative embodiments of the invention may comprise multiple instances of one or more of these or other drive components. For example, one such alternative embodiment may comprise multiple storage disks attached to the same spindle so all such disks rotate at the same speed, and multiple read/write heads and associated positioning arms coupled to one or more actuators. Also, both sides of storage disk 110 and any other storage disks in a particular embodiment may be used to store data and accordingly may be subject to read and write operations, through appropriate configuration of one or more read/write heads.

A given read/write head as that term is broadly used herein may be implemented in the form of a combination of separate read and write heads. More particularly, the term “read/write” as used herein is intended to be construed broadly as read and/or write, such that a read/write head may comprise a read head only, a write head only, a single head used for both reading and writing, or a combination of separate read and write heads. A given read/write head such as read/write head 130 may therefore include both a read head and a write head. Such heads may comprise, for example, write heads with wrap-around or side-shielded main poles, or any other types of heads suitable for recording and/or reading data on a storage disk. Read/write head 130 when performing write operations may be referred to herein as simply a write head.

Also, the storage device 100 as illustrated in FIG. 1 may include other elements in addition to or in place of those specifically shown, including one or more elements of a type commonly found in a conventional implementation of such a storage device. These and other conventional elements, being well understood by those skilled in the art, are not described in detail herein. It should also be understood that the particular arrangement of elements shown in FIG. 1 is presented by way of illustrative example only. Those skilled in the art will recognize that a wide variety of other storage device configurations may be used in implementing embodiments of the invention.

FIG. 2 shows the storage surface of the storage disk 110 in greater detail. As illustrated, the storage surface of storage disk 110 comprises a plurality of concentric tracks 210. Each track is subdivided into a plurality of sectors 220 which are capable of storing a block of data for subsequent retrieval. The tracks located toward the outside edge of the storage disk have a larger circumference when compared to those located toward the center of the storage disk. The tracks are grouped into several annular zones 230, where the tracks within a given one of the zones have the same number of sectors. Those tracks in the outer zones have more sectors than those located in the inner zones. In this example, it is assumed that the storage disk 110 comprises M+1 zones, including an outermost zone 230-0 and an innermost zone 230-M.

The outer zones of the storage disk 110 provide a higher data transfer rate than the inner zones. This is in part due to the fact that the storage disk in the present embodiment, once accelerated to rotate at operational speed, spins at a constant angular or radial speed regardless of the positioning of the read/write head, but the tracks of the inner zones have smaller circumference than those of the outer zones. Thus, when the read/write head is positioned over one of the tracks of an outer zone, it covers a greater linear distance along the disk surface for a given 360° turn of the storage disk than when it is positioned over one of the tracks of an inner zone. Such an arrangement is referred to as having constant angular velocity (CAV), since each 360° turn of the storage disk takes the same amount of time, although it should be understood that CAV operation is not a requirement of embodiments of the invention.

Areal and linear bit densities are generally constant across the entire storage surface of the storage disk 110, which results in higher data transfer rates at the outer zones. Accordingly, the outermost annular zone 230-0 of the storage disk has a higher average data transfer rate than the innermost annular zone 230-M of the storage disk. The average data transfer rates may differ between the innermost and outermost annular zones in a given embodiment by more than a factor of two. As one example embodiment, provided by way of illustration only, the outermost annular zone may have a data transfer rate of approximately 2.3 Gb/s, while the innermost annular zone has a data transfer rate of approximately 1.0 Gb/s. In such an implementation, the HDD may more particularly have a total storage capacity of 500 Gigabytes (GB) and a spindle speed of 7200 revolutions per minute (RPM), with the data transfer rates ranging, as noted above, from about 2.3 Gb/s for the outermost zone to about 1.0 Gb/s for the innermost zone.

The storage disk 110 may be assumed to include a timing pattern formed on its storage surface. Such a timing pattern may comprise one or more sets of servo address marks (SAMs) or other types of servo marks formed in particular sectors in a conventional manner.

The particular data transfer rates and other features referred to in the embodiment described above are presented for purposes of illustration only, and should not be construed as limiting in any way. A wide variety of other data transfer rates and storage disk configurations may be used in other embodiments.

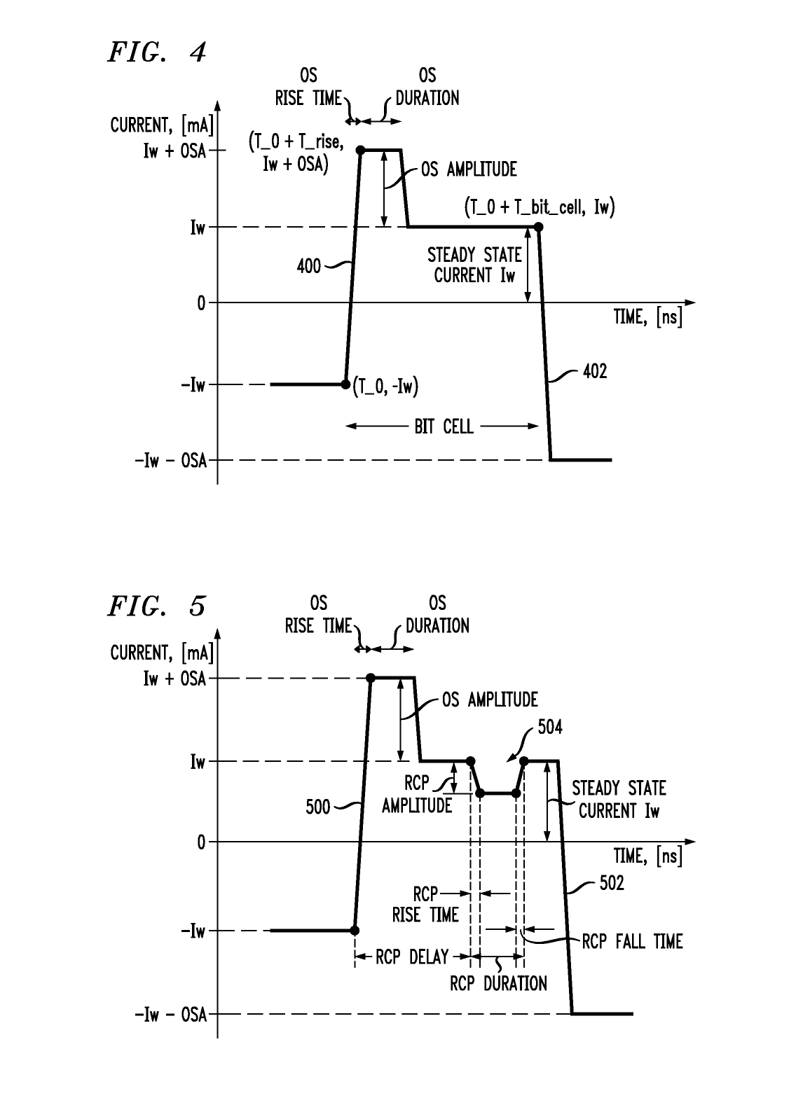

Embodiments of the invention will be described below in conjunction with FIGS. 3 to 8, in which the storage device 100 of FIG. 1 is configured to implement at least one write driver and associated reflection compensation circuitry. By way of example, the storage device 100 may be configured to operate in different modes of operation, including modes with and without reflection compensation. Examples of write pulse waveforms with and without reflection compensation will be described in greater detail below in conjunction with FIGS. 4 and 5, respectively.

FIG. 3 shows a portion of the storage device 100 of FIG. 1 in greater detail. In this view, the storage device 100 comprises a processor 300, a memory 302 and a system-on-a-chip (SOC) 304, which communicate over a bus 306. The storage device further comprises a preamplifier 308 providing an interface between the SOC 304 and the read/write head 130. The memory 302 is an external memory relative to the SOC 304 and other components of the storage device 100, but is nonetheless internal to that storage device. The SOC 304 in the present embodiment includes read channel circuitry 310 and a disk controller 312, and directs the operation of the read/write head 130 in reading data from and writing data to the storage disk 110.

The bus 306 may comprise, for example, one or more interconnect fabrics. Such fabrics may be implemented in the present embodiment as Advanced eXtensible Interface (AXI) fabrics, described in greater detail in, for example, the Advanced Microcontroller Bus Architecture (AMBA) AXI v2.0 Specification, which is incorporated by reference herein. The bus may also be used to support communications between other system components, such as between the SOC 304 and the preamplifier 308. It should be understood that AXI interconnects are not required, and that a wide variety of other types of bus configurations may be used in embodiments of the invention.

The processor 300, memory 302, SOC 304 and preamplifier 308 may be viewed as collectively comprising one possible example of “control circuitry” as that term is utilized herein. Numerous alternative arrangements of control circuitry may be used in other embodiments, and such arrangements may include only a subset of the components 300, 302, 304 and 308, or portions of one or more of these components. For example, the SOC 304 itself may be viewed as an example of “control circuitry.” The control circuitry of the storage device 100 in the embodiment as shown in FIG. 3 is generally configured to process data received from and supplied to the read/write head 130 and to control positioning of the read/write head 130 relative to the storage disk 110.

It should be noted that certain operations of the SOC 304 in the storage device 100 of FIG. 3 may be directed by processor 300, which executes code stored in external memory 302. For example, the processor 300 may be configured to execute code stored in the memory 302 for performing at least a portion of a reflection compensation process carried out by the SOC 304. Thus, at least a portion of the reflection compensation functionality of the storage device 100 may be implemented at least in part in the form of software code.

The external memory 302 may comprise electronic memory such as random access memory (RAM) or read-only memory (ROM), in any combination. In the present embodiment, it is assumed without limitation that the external memory 302 is implemented at least in part as a double data rate (DDR) synchronous dynamic RAM (SDRAM), although a wide variety of other types of memory may be used in other embodiments. The memory 302 is an example of what is more generally referred to herein as a “computer-readable storage medium.” Such a medium may also be writable.

Although the SOC 304 in the present embodiment is assumed to be implemented on a single integrated circuit, that integrated circuit may further comprise portions of the processor 300, memory 302, bus 306 and preamplifier 308. Alternatively, portions of the processor 300, memory 302, bus 306 and preamplifier 308 may be implemented at least in part in the form of one or more additional integrated circuits, such as otherwise conventional integrated circuits designed for use in an HDD and suitably modified to implement reflection compensation circuitry for providing one or more reflection compensation pulses for combination with respective write pulses of a write signal as disclosed herein.

An example of an SOC integrated circuit that may be modified for use in embodiments of the invention is disclosed in U.S. Pat. No. 7,872,825, entitled “Data Storage Drive with Reduced Power Consumption,” which is commonly assigned herewith and incorporated by reference herein.

Other types of integrated circuits that may be used to implement processor, memory or other storage device components of a given embodiment include, for example, a microprocessor, digital signal processor (DSP), application-specific integrated circuit (ASIC), field-programmable gate array (FPGA) or other integrated circuit device.

In an embodiment comprising an integrated circuit implementation, multiple integrated circuit dies may be formed in a repeated pattern on a surface of a wafer. Each such die may include reflection compensation circuitry as described herein, and may include other structures or circuits. The dies are cut or diced from the wafer, then packaged as integrated circuits. One skilled in the art would know how to dice wafers and package dies to produce packaged integrated circuits. Integrated circuits so manufactured are considered embodiments of the invention.

Although shown as part of the storage device 100 in the present embodiment, one or both of the processor 300 and memory 302 may be implemented at least in part within an associated processing device, such as a host computer or server in which the storage device is installed. Accordingly, elements 300 and 302 in the FIG. 3 embodiment may be viewed as being separate from the storage device 100, or as representing composite elements each including separate processing or memory circuitry components from both the storage device and its associated processing device. As noted above, at least portions of the processor 300 and memory 302 may be viewed as comprising “control circuitry” as that term is broadly defined herein.

Referring now more particularly to the preamplifier 308 of the storage device 100, the preamplifier in this embodiment comprises reflection compensation circuitry 320 and associated write drivers 322. The reflection compensation circuitry 320 comprises a delay control module 324 and a compensation pulse driver 326. The reflection compensation circuitry 320 is configured to provide one or more reflection compensation pulses in each of a plurality of write pulses of a write signal generated by a given one of the write drivers 322. Although multiple write drivers are present in this embodiment, other embodiments may include only a single write driver.

A given write driver 322 in the present embodiment may comprise multiple distinct data paths, such as a high side data path and a low side data path, although different numbers of data paths may be used in other embodiments. It should be noted in this regard that the term “data path” as used herein is intended to be broadly construed, so as to encompass, for example, CMOS circuitry or other types of circuitry through which a data signal passes in preamplifier 308 or another storage device component.

Also, the term “write driver” is intended to encompass any type of driver circuitry that may be used to deliver or otherwise provide one or more write signals to the write head of the storage device 100. By way of example, a given one of the write drivers 322 may comprise an X side and a Y side, each comprising both high side and low side drivers, where the X and Y sides are driven on opposite write cycles. Numerous alternative arrangements of circuitry are possible in other write driver embodiments.

Although illustratively shown in FIG. 3 as being separate from the write drivers 322, the reflection compensation circuitry 320 may alternatively be implemented at least in part internally to the write drivers 322.

FIGS. 4 and 5 illustrate write signals generated in the storage device 100, comprising respective write pulses without and with a superimposed reflection compensation pulse, respectively. More particularly, FIG. 4 shows an example of a write signal comprising a write pulse without a superimposed reflection compensation pulse, and FIG. 5 illustrates the manner in which FIG. 4 write signal can be modified to include a reflection compensation superimposed on the write pulse using the reflection compensation circuitry 320.

In each of these figures, a single write pulse is shown, suitable for use in writing a single data bit to the storage medium 110, and the write pulse current in milliamperes (mA) is plotted as a function of time in nanoseconds (ns).

A given exemplary write pulse of a write signal as illustrated in FIGS. 4 and 5 comprises a single-slope low-to-high data transition (i.e., from “0” to “1”) and a single-slope high-to-low data transition (i.e., from “1” to “0”). These low-to-high and high-to-low transitions are also referred to as rising and falling transitions, respectively. The slope of the rising transition or falling transition is characterized by a rise time or fall time as well as an amplitude difference between start and end points. The fall time may alternatively be characterized herein as a rise time for a transition of opposite polarity, and vice versa. It is to be appreciated that different types of write pulses may be used in other embodiments. For example, write pulses having multiple-slope data transitions may be used, as disclosed in U.S. patent application Ser. No. 13/416,443, filed Mar. 9, 2012 and entitled “Storage Device having Write Signal with Multiple-Slope Data Transition,” which is commonly assigned herewith and incorporated by reference herein.

Referring initially to FIG. 4, the write pulse as shown includes a single-slope rising transition 400 that begins at start time T_0 and at negative write current −Iw, where Iw denotes steady-state write current. The magnitude of the write current from zero to its peak value may be in the range of about 15 to 125 mA, although different values can be used. For example, higher peak values up to about 165 mA are used in some implementations. The single-slope rising transition 400 ends at time T_0+T_rise and at write current Iw+OSA, where T_rise denotes the rise time of the data transition and OSA denotes overshoot amplitude, also referred to as OS amplitude. The rise time T_rise is also denoted as OS rise time in the figure. The figure also shows OS duration of the write pulse. The portion of the write pulse between T_0 and T_bit_cell corresponds generally to a given bit cell, or more particularly a single data bit to be recorded on the storage disk 110 using the corresponding write pulse. The linear bit size is given approximately by the write head speed times T_bit_cell-T_0, where the write head speed is apparent speed relative to the spinning storage medium. The falling transition 402 of the FIG. 4 write pulse is similar to the rising transition, but starts at write current Iw and ends at write current −Iw-OSA.

FIG. 5 shows a modified write pulse that includes rising and falling data transitions 500 and 502 that are substantially the same as respective transitions 400 and 402 of FIG. 4, and further includes a superimposed reflection compensation pulse or RCP generally designated by reference numeral 504. It should be noted that the term “superimposed” in this context is intended to be broadly construed, so as to encompass a variety of different techniques for combining a reflection compensation pulse into a write pulse.

The inclusion of the superimposed reflection compensation pulse 504 allows mismatch-related reflections of the write pulse to be at least partially canceled out, thereby reducing distortion of the desired write pulse waveform and improving on-track and off-track recording performance, particularly at high data rates. As will be appreciated by those skilled in the art, the parameters of the reflection compensation pulse will be selected based on implementation-specific factors such as, for example, a length and impedance of a transmission line that couples a given write driver to a write head, the output impedance of the write driver and the input impedance of the write head.

The reflection compensation pulse 504 in FIG. 5 is superimposed on the write pulse between its rising transition 500 and its falling transition 502. The reflection compensation pulse 504 is characterized in this embodiment by amplitude, duration, rise time and fall time, and is also characterized by delay relative to the rising transition 500 of the write pulse, although other types of reflection compensation pulse waveforms may be used.

More particularly, in the present embodiment, the reflection compensation pulse is a negative-going current pulse having a substantially zero steady-state current. The reflection compensation pulse is superimposed on the write pulse by combining the negative-going current pulse having the substantially zero steady-state current with a positive steady-state write current Iw of the write pulse so as to produce a modified write pulse having the negative-going current pulse superimposed on the positive steady-state write current.

In the FIG. 5 embodiment, only a single reflection compensation pulse 504 is superimposed on the write pulse, but other embodiments may utilize multiple reflection compensation pulses superimposed on a given write pulse, each possibly with different parameters such as amplitude, duration, rise time, fall time and delay.

It should also be understood that FIG. 5 illustrates just one possible way of providing a reflection compensation pulse in a write pulse used to write data to a storage medium. Other techniques may be used to superimpose, combine or otherwise provide one or more reflection compensation pulses in a given write pulse of a write signal in other embodiments.

FIG. 6A shows circuitry 600 of the storage device 100 including a more detailed view of a portion of the reflection compensation circuitry 320 associated with a given write driver 322-1. In this embodiment, the reflection compensation circuitry 320 is assumed to include a separate delay control module 324-1 and separate compensation pulse driver 326-1 for the write driver 322-1. Each additional write driver of the set of write drivers 322 may similarly include separate instances of the delay control module and compensation pulse driver. Alternatively, single instances of these elements may be associated with multiple write drivers in the set of write drivers 322.

The given write driver 322-1 may be viewed as representing only a portion of a high side or low side data path in an embodiment comprising multiple write data paths. At least a portion of each such data path may comprise separate steady-state and overshoot paths, which include respective circuitry blocks for steady-state and overshoot write pulse waveshaping. Thus, for example, write driver 322-1 may comprise separate steady-state and overshoot drivers, as would be appreciated by those skilled in the art. Also, the portion of reflection compensation circuitry 322 shown is implemented outside of the write driver 322-1 in this embodiment, but as noted above, in other embodiments may be implemented at least in part using circuitry that is internal to the write driver 322-1.

As shown in FIG. 6A, the write driver 322-1 receives a data pattern to be written to the storage disk 110, and generates a corresponding write signal that is applied to an input of a signal combiner 602-1 of the reflection compensation circuitry 320. The output of the signal combiner 602-1 is coupled via a transmission line 604-1 to the write head 130W. The write signal as generated by the write driver and applied to signal combiner 602-1 includes a plurality of write pulses associated with respective data bits of the data pattern, but does not include reflection compensation pulses. This write signal is also referred to in the context of FIG. 6B as a main driver signal 606 and may be viewed as comprising write pulses of the type previously described in conjunction with FIG. 4.

The write signal generated by the write driver 322-1 is also applied as an input to the delay control module 324-1. The delay control module 324-1 is an example of what is more generally referred to herein as a “controllable delay element.” The compensation pulse driver 326-1 has an input coupled to an output of the delay control module 324-1 and an output coupled to a second input of the signal combiner 602-1. The delay control module 324-1 is configured to operate in conjunction with the compensation pulse driver 326-1 to establish a delay time of an initial transition of a given one of the reflection compensation pulses relative to an initial transition of the write pulse. For example, the established delay time in some implementations may be approximately twice the signal propagation time between the write driver 322-1 and the write head 130W.

The signal combiner 602-1 superimposes the given reflection compensation pulse on a corresponding write pulse of the write signal generated by the write driver, and supplies the resulting modified write pulse to write head 130W via a transmission line 604-1. The transmission line is also referred to in the figure as a “T-line.” The modified write pulse is also referred to herein as a write pulse that is provided with one or more reflection compensation pulses. Such a write pulse as modified in the manner described so as to incorporate one or more reflection compensation pulses may be considered part of a write signal that is generated by a write driver for delivery to the write head 130W, as the term “write signal” is intended to be broadly construed herein.

The given reflection compensation pulse is also referred to in the context of FIG. 6B as an RC driver pulse 608. It can be seen in FIG. 6B that the reflection compensation pulse as illustrated there is a negative-going current pulse having a substantially zero steady-state current 610. As indicated previously, the reflection compensation pulse is superimposed on the write pulse of the main driver signal 606 by combining the negative-going current pulse 608 having the substantially zero steady-state current 610 with the positive steady-state write current 1w of the write pulse so as to produce a modified write pulse having the negative-going current pulse 608 superimposed on the positive steady-state write current Iw.

The output of the signal combiner 602-1 is coupled via a transmission line 604-1 to the write head 130W. As illustrated in FIG. 6C, which shows another view of circuitry 600 of the storage device 100, the reflection compensation pulse is generated by an RC driver 620 and the write pulse is generated by main driver 622. The RC driver 620 may be viewed as comprising elements 324-1, 326-1 and 602-1 of FIG. 6A, and the main driver 622 may be viewed as comprising the write driver 322-1 of FIG. 6A. The drivers 620 and 622 are therefore considerably simplified in FIG. 6C in order to illustrate the transmission line impedance aspects of this embodiment, but may be viewed collectively as an example of a “write driver” as that term is broadly used herein. The transmission line 604-1 has a designated finite input impedance established by resistor-capacitor circuitry 625 coupled at an input side of the transmission line 604-1 between first and second conductors 626 and 628 of the transmission line. The resistor-capacitor circuitry 625 as illustrated in FIG. 6C comprises at least one resistor R in parallel with at least one capacitor C, although other arrangements of circuit elements may be used in other embodiments.

As a more particular example, the resistor R in the FIG. 6C embodiment may have a value of approximately 50 Ohms and the capacitor C may have a value of approximately 1 picoFarad (pF). With these values, the capacitance starts to contribute significantly to the total impedance at data rates greater than about 1 Gb/s. The reflection compensation functionality becomes increasingly effective at improving performance as data rates increase above 1 Gb/s, such that increasingly significant performance improvements are provided for data rates of about 2 Gb/s and 2.5 Gb/s.

For the exemplary R and C values given above, and assuming a steady-state current Iw of 50 mA, an OS amplitude of 50 mA, an OS duration of 0.1 ns, and main pulse rise and fall times of 0.1 and 0.05 ns, respectively, possible values for the RCP amplitude, RCP duration, RCP rise and fall times and RCP delay as illustrated in FIG. 5 are given by −35 mA, 0.01 ns, 0.06 ns, 0.085 ns and 0.5 ns, respectively. A wide variety of other parameter values, transmission line impedances, and write pulse and reflection compensation pulse shapes may be used in other embodiments.

The use of finite input impedance for the transmission line 604-1 as established by the resistor-capacitor circuitry 625 allows the reflection compensation pulse 608 to be generated at significantly lower amplitude than would otherwise be required and without a positive or negative steady-state component, thereby reducing the amount of power required to generate the reflection compensation pulse.

Referring again to FIG. 6A, the write pulse parameters such as OS amplitude, OS duration, Iw, T_rise and T_bit_cell are determined by write pulse setting control signals applied to the write driver 322-1. The reflection compensation pulse parameters are controlled by delay time setting control signals applied to the delay control module 324-1 and compensation pulse setting control signals applied to the compensation pulse driver 326-1. These control signals may be provided at least in part by other components of the storage device 100, such as processor 300 or SOC 304. Numerous other techniques for providing controllable parameters for the write pulses and associated reflection compensation pulses of a write signal as disclosed herein will be apparent to those skilled in the art. Also, static control circuitry may be used, in which at least a subset of the write pulse and reflection compensation pulse parameters are not dynamically controllable but are instead fixed.

One or more of the embodiments of the invention provide significant improvements in disk-based storage devices as well as other types of storage devices. For example, by utilizing write signals having write pulses with superimposed reflection compensation pulses, mismatch-related reflections of the write pulse are at least partially canceled out. This can significantly reduce distortion of the desired write pulse waveform and thereby improve on-track and off-track recording performance, particularly at high data rates.

It is to be appreciated that the particular circuitry arrangements, write signal waveforms and control signal configurations shown in FIGS. 3-6 are presented by way of example only, and other embodiments of the invention may utilize other types and arrangements of elements for implementing reflection compensation functionality for one or more write signals as disclosed herein.

As mentioned previously, the storage device configuration can be varied in other embodiments of the invention. For example, the storage device may comprise a hybrid HDD which includes a flash memory in addition to one or more storage disks.

It should also be understood that the particular storage disk configuration and recording mechanism can be varied in other embodiments of the invention. For example, a variety of recording techniques including shingled magnetic recording (SMR), bit-patterned media (BPM), heat-assisted magnetic recording (HAMR) and microwave-assisted magnetic recording (MAMR) can be used in one or more embodiments of the invention. Accordingly, embodiments of the invention are not limited with regard to the particular types of storage media that are used in a given storage device.

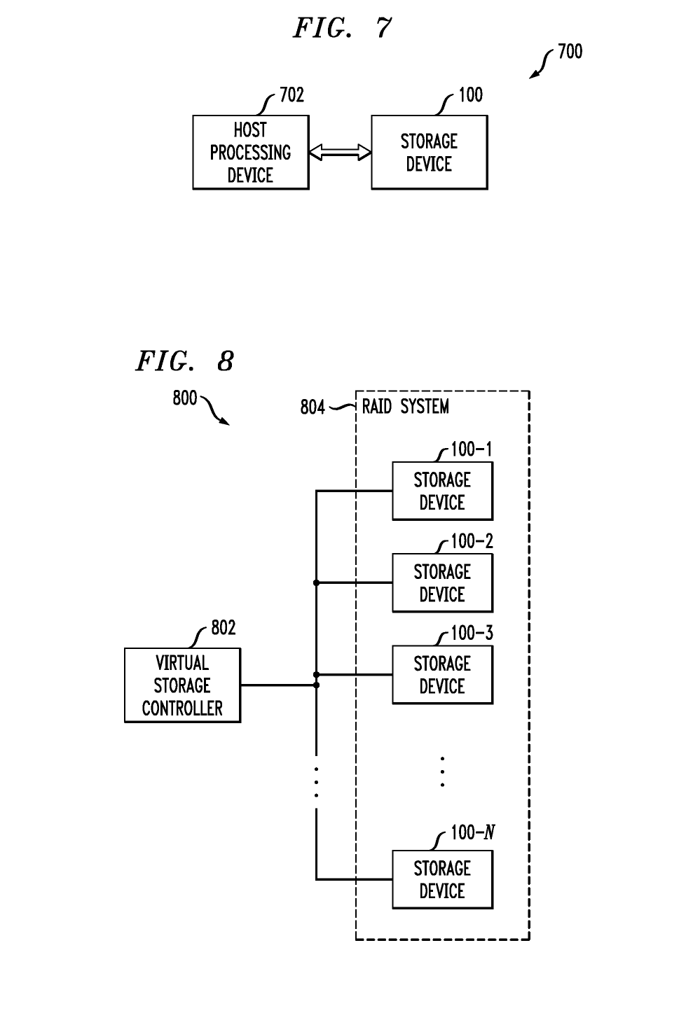

FIG. 7 illustrates a processing system 700 comprising the disk-based storage device 100 coupled to a host processing device 702, which may be a computer, server, communication device, etc. Although shown as a separate element in this figure, the storage device 100 may be incorporated into the host processing device. Instructions such as read commands and write commands directed to the storage device 100 may originate from the processing device 702, which may comprise processor and memory elements similar to those previously described in conjunction with FIG. 3.

Multiple storage devices 100-1 through 100-N possibly of various different types may be incorporated into a virtual storage system 800 as illustrated in FIG. 8. The virtual storage system 800, also referred to as a storage virtualization system, illustratively comprises a virtual storage controller 802 coupled to a RAID system 804, where RAID denotes Redundant Array of Independent storage Devices. The RAID system more specifically comprises N distinct storage devices denoted 100-1, 100-2, . . . 100-N, one or more of which may be HDDs and one or more of which may be solid state drives. Furthermore, one or more of the HDDs of the RAID system are assumed to be configured to include reflection compensation circuitry for generating reflection compensation pulses for combination with corresponding write pulses as disclosed herein. These and other virtual storage systems comprising HDDs or other storage devices of the type disclosed herein are considered embodiments of the invention. The host processing device 702 in FIG. 7 may also be an element of a virtual storage system, and may incorporate the virtual storage controller 802.

Again, it should be emphasized that the above-described embodiments of the invention are intended to be illustrative only. For example, other embodiments can use different types and arrangements of storage media, write heads, control circuitry, preamplifiers, write drivers, reflection compensation circuitry and other storage device elements for implementing the described write signal generation functionality. Also, the particular manner in which one or more reflection compensation pulses are superimposed on or otherwise provided in each of a plurality of write pulses, as well as the various parameters and waveforms used for the reflection compensation pulses, may be varied in other embodiments. These and numerous other alternative embodiments within the scope of the following claims will be apparent to those skilled in the art.

1. An apparatus comprising:
control circuitry adapted for coupling to a write head configured to write data to a storage medium;
wherein the control circuitry comprises:
a write driver configured to generate a write signal comprising a write pulse; and
reflection compensation circuitry associated with the write driver and configured to provide one or more reflection compensation pulses in said write pulse;
wherein the reflection compensation circuitry comprises:
a controllable delay element; and
a reflection compensation pulse driver having an input coupled to an output of the controllable delay element;
wherein the controllable delay element is coupled between the write driver and the reflection compensation pulse driver, and is configured to operate in conjunction with the reflection compensation pulse driver to establish a delay time of an initial transition of a given one of the reflection compensation pulses relative to an initial transition of the write pulse.

2. The apparatus of claim 1 wherein the write pulse comprises a rising transition and a falling transition, and the reflection compensation circuitry is configured to superimpose a given one of the reflection compensation pulses on the write pulse between the rising transition and the falling transition.

3. The apparatus of claim 2 wherein the given reflection compensation pulse is characterized by an amplitude, a duration, a rise time and a fall time.

4. The apparatus of claim 2 wherein the given reflection compensation pulse is characterized by a delay relative to the rising transition of the write pulse.

5. The apparatus of claim 1 wherein the reflection compensation circuitry is configured to generate a given one of the reflection compensation pulses as a negative-going current pulse having a substantially zero steady-state current.

6. The apparatus of claim 5 wherein the reflection compensation circuitry is configured to superimpose the given reflection compensation pulse on the write pulse by combining the negative-going current pulse having the substantially zero steady-state current with a positive steady-state write current of the write pulse so as to produce a modified write pulse having the negative-going current pulse superimposed on the positive steady-state write current.

7. The apparatus of claim 1 wherein the write pulse having the one or more reflection compensation pulses provided therein is transmitted via a transmission line to the write head wherein the transmission line has a designated finite input impedance established by resistor-capacitor circuitry coupled at an input side of the transmission line between first and second conductors of the transmission line.

8. The apparatus of claim 1 wherein the reflection compensation circuitry is at least partially incorporated into the write driver.

9. (canceled)

10. The apparatus of claim 1 wherein the reflection compensation circuitry further comprises a signal combiner having a first input coupled to an output of the write driver, a second input coupled to an output of the reflection compensation pulse driver, and an output adapted for coupling to the write head via a transmission line.

11. The apparatus of claim 1 wherein the controllable delay element has an input coupled to an output of the write driver.

12. The apparatus of claim 1 wherein the control circuitry is fabricated in at least one integrated circuit.

13. A storage device comprising the apparatus of claim 1.

14. A virtual storage system comprising the storage device of claim 13.

15. The apparatus of claim 1 wherein the control circuitry further comprises:
at least one integrated circuit comprising a disk controller and read channel circuitry; and
a preamplifier adapted for coupling between said at least one integrated circuit and the write head;
wherein the write driver and its associated reflection compensation circuitry are implemented in the preamplifier.

16. The apparatus of claim 1 comprising a processor and a memory coupled to the processor, wherein at least a portion of the control circuitry is implemented by the processor executing software code stored in the memory.

17. A method comprising the steps of:
receiving data to be written to a storage medium of a storage device;
generating a write signal for the data to be written to the storage medium, the write signal comprising a write pulse having one or more reflection compensation pulses provided therein; and
controlling a delay element to establish a delay time of an initial transition of a given one of the reflection compensation pulses relative to an initial transition of the write pulse, wherein the delay element is coupled between a write driver and a reflection compensation pulse driver.

18. The method of claim 17 wherein the step of generating a write signal further comprises:
generating a given one of the reflection compensation pulses as a negative-going current pulse having a substantially zero steady-state current; and
superimposing the given reflection compensation pulse on the write pulse by combining the negative-going current pulse having the substantially zero steady-state current with a positive steady-state write current of the write pulse so as to produce a modified write pulse having the negative-going current pulse superimposed on the positive steady-state write current.

19. A non-transitory computer-readable storage medium having embodied therein executable code for performing the steps of the method of claim 17.

20. A processing system comprising:
a processing device; and
a storage device coupled to the processing device and comprising at least one storage medium;
wherein the storage device further comprises:
a write head configured to write data to the storage medium; and
control circuitry coupled to the write head;
the control circuitry comprising:
a write driver configured to generate a write signal comprising a write pulse; and
reflection compensation circuitry associated with the write driver and configured to provide one or more reflection compensation pulses in said write pulse;
wherein the reflection compensation circuitry comprises:
a controllable delay element; and
a reflection compensation pulse driver having an input coupled to an output of the controllable delay element;
wherein the controllable delay element is coupled between the write driver and the reflection compensation pulse driver, and is configured to operate in conjunction with the reflection compensation pulse driver to establish a delay time of an initial transition of a given one of the reflection compensation pulses relative to an initial transition of the write pulse.
